(19) United States
(12) Patent Application Publication
(10) Pub. No.: US 2024/0087396 A1
(43) Pub. Date: Mar. 14, 2024

(54) APPARTUS, METHODS AND SYSTEMS FOR REPOSITIONING ITEMS WITHIN A CARTRIDGE FOR STORING AND CONVEYING ITEMS WITHIN A FOOD DELIVERY APPARATUS

(71) Applicant: Roboburger Enterprises, Inc., Newark, NJ (US)

(72) Inventors: Daniel Braido, Jersey City, NJ (US); Audley Wilson, Newark, NJ (US); Theodore Halbach, Newark, NJ (US)

(21) Appl. No.: 18/517,464

(22) Filed: Nov. 22, 2023

Related U.S. Application Data
(63) Continuation-in-part of application No. 18/133,947, filed on Apr. 12, 2023.
Application No. 18/133,947 is a continuation of application No. 18/077,913, filed on Dec. 8, 2022, now Pat. No. 11,721,158.
Application No. 18/077,913 is a continuation-in-part of application No. PCT/US22/35910, filed on Jul. 1, 2022.
Application No. PCT/US22/35910 is a continuation of application No. 17/375,038, filed on Jul. 14, 2021, now Pat. No. 11,335,154.
Application No. 18/133,947 is a continuation-in-part of application No. 17/856,044, filed on Jul. 1, 2022.
Application No. 17/856,044 is a continuation-in-part of application No. PCT/US21/16448, filed on Feb. 3, 2021.
Application No. PCT/US21/16448 is a continuation of application No. 16/780,131, filed on Feb. 3, 2020, now Pat. No. 11,019,960.

(51) Int. Cl. G07F 11/58; B65G 13/02

(52) U.S. Cl. CPC G07F 11/58; B65G 13/02

(57) ABSTRACT

A cartridge having a housing, an outer looped element affixed at least partially in a cavity that spans substantially all of a length of the housing. A movable inner looped element is mounted a roller and positioned inside the outer looped element. Panels are radially attached to the movable inner looped element such that each of the plurality of panels extends toward the outer looped element. Movable chambers defined by a space between the panels. A first opening that spans substantially all of a first side of the outer looped element. A portion of the outer looped element defines a planar surface at a lower end portion of the outer looped element. An elongated tab extends from an end of the planar surface and protrudes into a portion of the first opening.

### CROSS-REFERENCE TO RELATED APPLICATIONS

This application is a continuation in part that claims the benefit of U.S. Non-provisional application Ser. No. 18/133,947 entitled “APPARATUS, METHODS, AND SYSTEM FOR VENDING AN ASSEMBLED FOOD ITEM FROM A VENDING APPARATUS” and filed Apr. 12, 2023 the subject matter of which is incorporated herein by reference, which is a continuation-in-part that claims the benefit of U.S. Non-provisional application Ser. No. 18/077,913 titled “APPARATUS, METHODS AND SYSTEMS FOR DISPENSING AN ITEM FROM A DISPENSING APPARATUS” and filed Dec. 8, 2022 the subject matter of which is incorporated herein by reference, which is a continuation-in-part of and claims priority to United States PCT Application Serial No. PCT/US22/35910, titled “APPARATUS, METHODS AND SYSTEMS FOR STORING AND CONVEYING ITEMS WITHIN A FOOD DELIVERY APPARATUS” and filed Jul. 1, 2022 which claims priority to U.S. patent application Ser. No. 17/375,038 titled “APPARATUS, METHODS AND SYSTEMS FOR STORING AND CONVEYING ITEMS WITHIN A FOOD DELIVERY APPARATUS” and filed Jul. 14, 2021, now patented as U.S. Pat. No. 11,335,154 and issued May 17, 2022, each of which the subject matter disclosed therein is incorporated herein by reference.

The U.S. Non-provisional application Ser. No. 18/133,947 entitled “APPARATUS, METHODS, AND SYSTEM FOR VENDING AN ASSEMBLED FOOD ITEM FROM A VENDING APPARATUS” and filed Apr. 12, 2023 is also a continuation-in-part of and claims the benefit of U.S. patent application Ser. No. 17/856,044, titled “APPARATUS, METHODS, AND SYSTEM FOR AUTOMATICALLY FOLDING A BOX FOR FAST FOOD DELIVERY” and filed Jul. 1, 2022, which is a continuation-in-part of and claims priority to United States PCT Application Serial No. PCT/US21/16448 titled APPARATUS AND METHOD FOR PREPARING COOKED FOOD″ and filed Feb. 3, 2021, which claims priority to U.S. patent application Ser. No. 16/780,131 titled “APPARATUS AND METHOD FOR PREPARING COOKED FOOD” and filed Feb. 3, 2020, now patented as U.S. Pat. No. 11,019,960 and issued Jun. 1, 2021, each of which the subject matter disclosed therein is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of food preparation, and more specifically to the field of automated food preparation devices.

### BACKGROUND

Safe food supplies support national economies, trade, and tourism, contribute to food and nutritional security, and underpin sustainable development. However, foodborne diseases encompassing a wide spectrum of illnesses are a growing public health problem worldwide. Foodborne diseases account for an estimated 76 million illnesses, 350,000 hospitalizations and 5,000 deaths every year in the United States, according to the Centers for Disease Control and Prevention. Moreover, according to the World Health Organization (WHO), an estimated 600 million people—almost 10 percent of the global population—fall ill after eating contaminated food.

Protecting the public from the degrees of the harmfulness of contaminated foods has become a daunting task. Automated food preparation devices are being increasingly used in the food industry as a means of preventing food contamination. Although automated food preparation devices have potential food safety benefits, such as the need for fewer workers and reducing the risk of contamination through manual handling, the implementation of suitable devices that prevent contamination is necessary. In addition, the automated food preparation devices involve moving or rotating components that are prone to jamming or clogging issues due to wear and tear of machine components or other factors such as when the food items inside get stuck or fail to drop properly into the delivery tray. The other factors also include unwanted shifting or misalignment of food items over time or with movement of the components, causing them to block the movement. To address jamming issues, machine operators often need to periodically reposition the items inside. This may involve adjusting the placement of products on the shelves, ensuring they are correctly aligned and spaced. Operators may also need to clean the dispensing mechanisms of these devices and remove any foreign objects that may be causing jams.

In another aspect, automated food preparation devices inherently involve the transportation of food products. Transportation is another potential source of contamination that must be considered when designing automated food preparation devices. Given the impact of these human factors, there exists a need to improve over the prior art and more particularly, for devices that prevent contamination of food products.

### SUMMARY

A cartridge to be used in a food delivery apparatus is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a cartridge to be used in a food delivery apparatus is disclosed. In one embodiment, the cartridge is for storing and conveying food items and comprises (a) a housing having a plurality of walls defining a main cavity, (b) an outer looped element affixed at least partially in the main cavity, (c) a plurality of rotatable rollers spaced apart from each other and positioned inside the outer looped element, (d) a movable inner looped element mounted on the plurality of rotatable rollers and positioned inside the outer looped element, (e) a plurality of panels, wherein a first end of each of the plurality of panels is radially attached to the movable inner looped element such that each of the plurality of panels extends toward the outer looped element, (f) a plurality of movable chambers between the outer looped element and the movable inner looped element, wherein each of the plurality of movable chambers is defined by a space between a first panel of the plurality of panels and an adjacent panel of the plurality of panels that is next to the first panel, (g) a first opening that spans substantially all of a first side of the outer looped element, (h) a movable door covering substantially all of the first opening and partially defining the outer looped element when the movable door is in a movable door closed position, (I) a portion of the outer looped element that defines a planar surface at a lower end portion of the outer looped element, and (j) an elongated tab extending from an end of the planar surface and protruding into a portion of the first opening.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1a is a front view of a cartridge for storing and conveying food items, according to an example embodiment;

FIG. 1B is a perspective view of a cartridge for storing and conveying food items, according to an example embodiment;

FIG. 1c is a first side view of a cartridge for storing and conveying food items, illustrating a motor (located inside a housing), according to an example embodiment;

FIG. 1d is a second side view of a cartridge for storing and conveying food items, according to an example embodiment;

FIG. 2a is a cutaway, side view of a cartridge for storing and conveying food items, according to an example embodiment;

FIG. 2b is a cutaway, perspective side view of a cartridge for storing and conveying food items, according to an example embodiment;

FIG. 3 is a zoomed-in view of the encircled portion of FIG. 2a of a plurality of panels inside of the cartridge for storing and conveying food items, according to an example embodiment;

FIG. 4a is a side perspective view of a cartridge for storing and conveying food items showing a cutaway of the housing for a motor that drive a plurality of rotatable rollers, according to an example embodiment;

FIG. 4b is a second side view (cutaway) of a cartridge for storing and conveying food items showing a cutaway of the housing for a motor that drive a plurality of rotatable rollers, according to an example embodiment;

FIG. 5a is a cutaway view of a lower portion of a cartridge for storing and conveying food items, according to an example embodiment;

FIG. 5b is a cutaway view of a lower portion of a cartridge for storing and conveying food items, according to an example embodiment;

FIG. 5c is a cutaway view of chambers in a lower portion of a cartridge for storing and conveying food items, according to an example embodiment;

FIG. 5d is a perspective cutaway view of a lower portion of a cartridge for storing and conveying food items, according to an example embodiment;

FIG. 5e is a perspective cutaway view of a lower portion of a cartridge for storing and conveying food items, according to an example embodiment;

FIG. 5f is a bottom perspective cutaway view of a lower portion of a cartridge, according to an example embodiment;

FIG. 5g is a bottom perspective cutaway view of a lower portion of a cartridge, according to another example embodiment; and

FIG. 6 is a flowchart of an example method for storing and conveying food items in a cartridge of a food delivery apparatus, in accordance with an embodiment of the invention.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a cartridge that can readily be loaded in a food safe preparation area that is remote from the location of use for the cartridge. Furthermore, the cartridge is easily sanitized and maintains sanitary conditions throughout the food preparation process, from the food safe preparation area, and to the final location of the cartridge where it will be used. The cartridge provides a hermetically sealed environment to protect the food items inside the cartridge from contamination. In an embodiment, the cartridge has a repositioning system or system for repositioning that prevents food items from falling off the chambers when the chambers are moving and prevents jamming of the cartridge due to trapped food items.

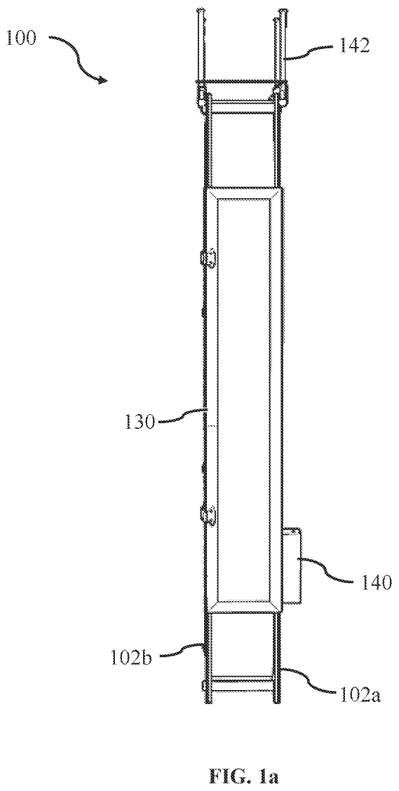

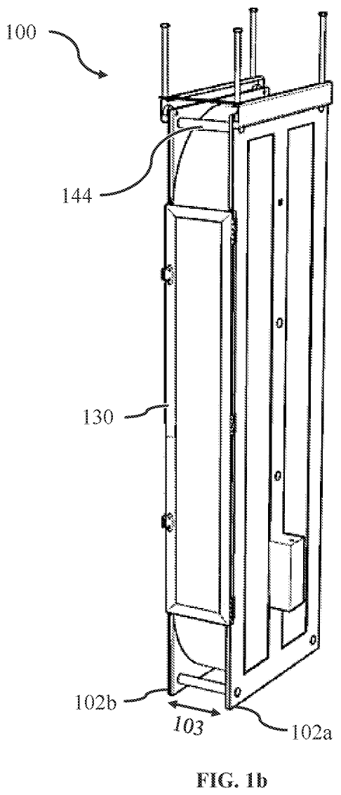

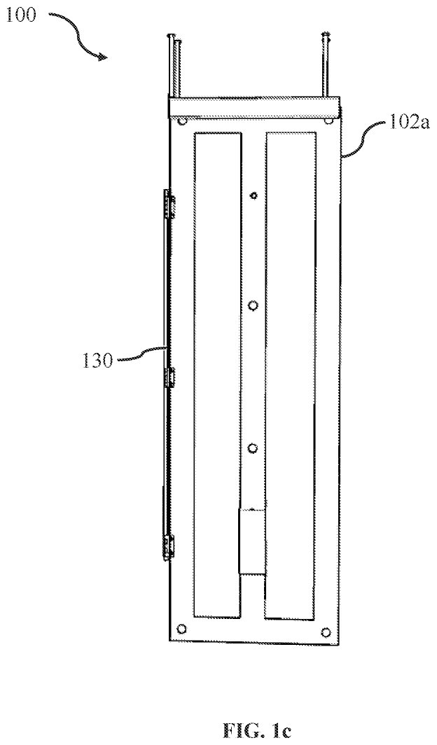

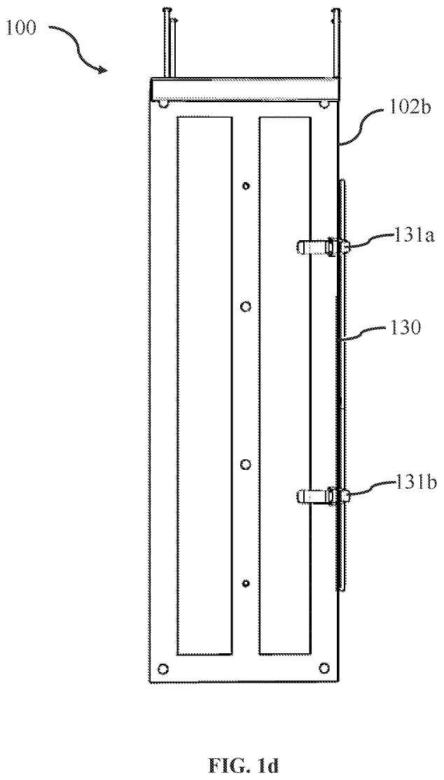

Referring now to the Figures, and to FIGS. 1a-1d specifically, a cartridge (100) to be used in a food delivery apparatus is shown. FIG. 1a shows a side view of the cartridge (100), FIG. 1B shows a perspective view of the cartridge (100), FIG. 1c shows a first side view of the cartridge (100) and FIG. 1d shows a second side view of the cartridge. As shown, the cartridge (100) includes a housing (101) defined by a plurality of walls (102a-102b) defining a main cavity (103) inside the housing. In the present embodiment, it is understood that the term cavity or main cavity means a space between the at least two walls. In the present embodiment, the housing only has two walls. However, it is understood that in other embodiments, additional walls or panels may be used and are within the spirit and scope of the present invention. The plurality of walls (102a-102b) may be made of any suitable material. For instance, the walls may be comprised of or consist of a metal or metal alloy, or a polymeric material. Preferably, the walls consist of a metal or metal alloy having a smooth surface that enables rapid and complete sanitization of the surface when necessary. In a preferred embodiment, the walls comprise or consist of an aluminum alloy. For instance, aluminum alloys such as a lxxx series aluminum alloy, a 3xxx series aluminum alloy, a 5xxx series aluminum alloy, or a 6xxx series aluminum alloy may be used. A stainless steel alloy, such as grades 304, 316, or 400 may also be used. The walls may be sealed with silicone rubber to obtain a hermetic seal.

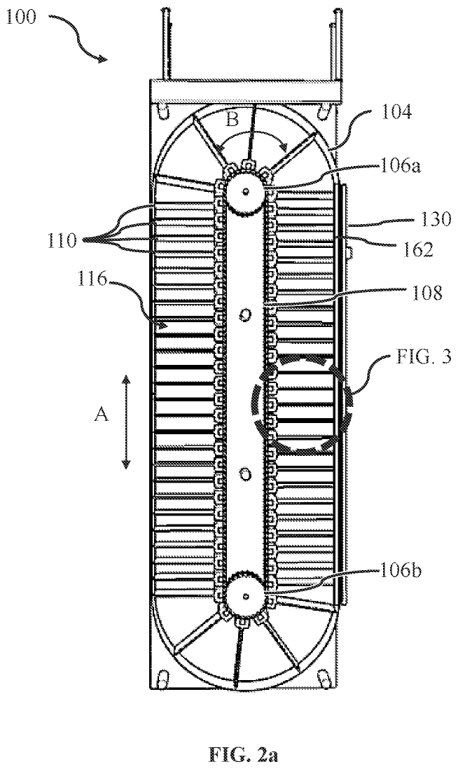

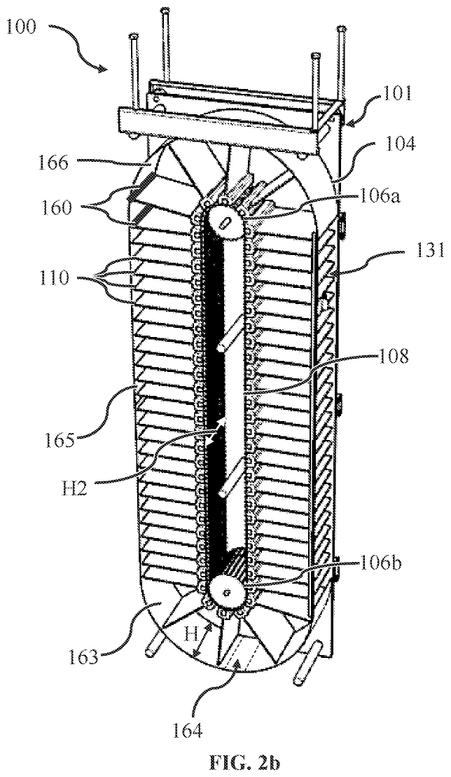

The cartridge also includes a first movable door (130) covering a first opening (131). The first opening (131) provides access to inside the outer looped element between the two walls (102a-102b) of the housing. The cartridge (100) may be locked using at least one fastener, such as the clasp and clasp hook fasteners (131a) and (131b) depicted in the figures. The fasteners may be similarly made of a metal, metal alloy, or polymeric material as described above. The aluminum alloys and stainless steel alloys may be used, for example, as materials in the fasteners. The door (130) provides access to the cartridge when the cartridge (100) is to be filled with food items. As will be described below, the cartridge includes a plurality of movable chambers defined by a plurality of panels for placing the food items. A first portion of the plurality of chambers may be accessed when the door (130) is open and provides access into the chamber via the first opening (131). The movable inner looped element may be rotated, such that the operator can access the second portion of the plurality of chambers, as needed. In one embodiment, an inward facing wall portion (162) of the first movable door (130) at least partially defines the outer looped element and covers a first opening (131) (as illustrated in FIG. 2a). The movable door may include gaskets such that it provides a seal or hermetically sealed chamber.

The cartridge (100) may be mounted in any machine or device for preparing food. In the depicted embodiment, the cartridge (100) is envisioned for use in a vending machine. The cartridge (100) may be mounted within an enclosure. For instance, cartridge (100) may include carriage bolts (142) at an upper end of the cartridge (100) for hanging the cartridge inside of a vending machine. In other embodiments, the cartridge may be fastened or mounted to the vending machine by other means. For example, the cartridge may be mounted by rails to the vending machine. However, other means for mounting or attaching the cartridge to the vending machine may be used and is within the spirit and scope of the present invention. The cartridge design could also allow for the cartridge to rest on a surface, or to be hung using other portions of the cartridge. For instance, spacer rods (144) may be used to hang the cartridge. Moreover, spacer rods (144) provide structure to the device through connection with the walls (102a, 102b). The spacer rods (144) also dampen torsion stresses that may be placed upon the cartridge.

In another aspect of the invention, the cartridge (100) design may use a variety of fasteners that do not require any tool(s) to fasten or unfasten. The use of such fasteners may be necessary to comply with local or national laws and regulations. In this aspect, fasteners such as thumb screws, wing nuts, and cotter pin clips may be used, among others.

With reference to the figures now including FIGS. 2a-2b, the inner components of the cartridge (100) of FIGS. 1a-1d are shown. In this regard, FIG. 1a shows a front view of the inner components of the cartridge (100), and FIG. 2b shows a perspective view of the inner components. The cartridge as illustrated (100) includes an outer looped element (104) affixed at least partially in the main cavity (103). In one embodiment, the outer looped element (104) is elongated and has a length that spans substantially all of the full length of the housing. In an example, the length of the outer looped element (104) is equal to the length of the housing. Furthermore, the outer looped element (104) has a height H that spans from a first inside surface of a first side wall of one of the plurality of walls (102a) to a second inside surface of a second side wall of one of the plurality of walls (102a). The outer looped element (104) may be rigid. For instance, the outer looped element may be fabricated from any suitable material, such as a metal, metal alloy, or polymeric material. As illustrated in FIG. 2a, the inward facing wall portion (162) of the door (130) at partially defines the inward facing wall of the outer looped element. In one embodiment, the inward facing wall is such that the inward facing wall portion (162) of the first movable door (130) at least partially defines the outer looped element (104) and covers the first opening (131) such that a completely looped shaped element is defined. Additionally, the inward facing wall portion (162) of the first movable door (130) may be configured to be substantially “flush” with the other sections of the inward facing wall portions (162), (163), (165), (166) of the outer looped element defining the entire looped inward facing wall.

Similar to the outer looped element, the inner looped element (108) has a height (H2) that spans from a first inside surface of a first side wall of one of the plurality of walls (102a) to a second inside surface of a second side wall of one of the plurality of walls (102a) such that the sides of the inner looped element (or seal attached to the inner looped element) create a seal, a hermetic seal or at least a portion of a hermetic seal of the chamber. In certain embodiments, at least a partially hermetically sealed chamber is formed by combination of (i) the side edges (or sealing elements attached thereto) of the inner looped element (108) abutting the inside surface of the opposing walls, (ii) the second end of the panels (or sealing elements attached thereto) abutting the outer looped element, and (iii) the sides (or sealing elements attached thereto) of the outer looped element abutting the opposing walls. However, it is understood that different variations may be used to provide a hermetically sealed chamber may be used and are within the spirit and scope of the present invention.

As mentioned above, the aluminum alloy or stainless steel alloy materials may be used. In one embodiment, a 3xxx series aluminum alloy is used. In one embodiment, the aluminum alloy is AA3003. However other materials may be used and are within the spirit and scope of the present invention.

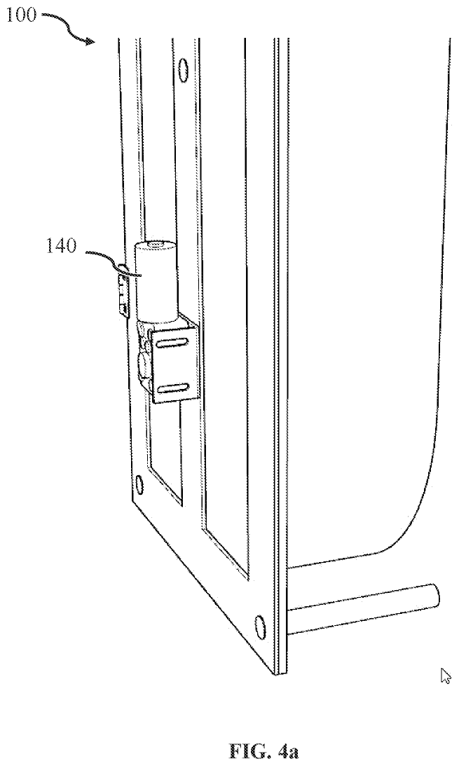

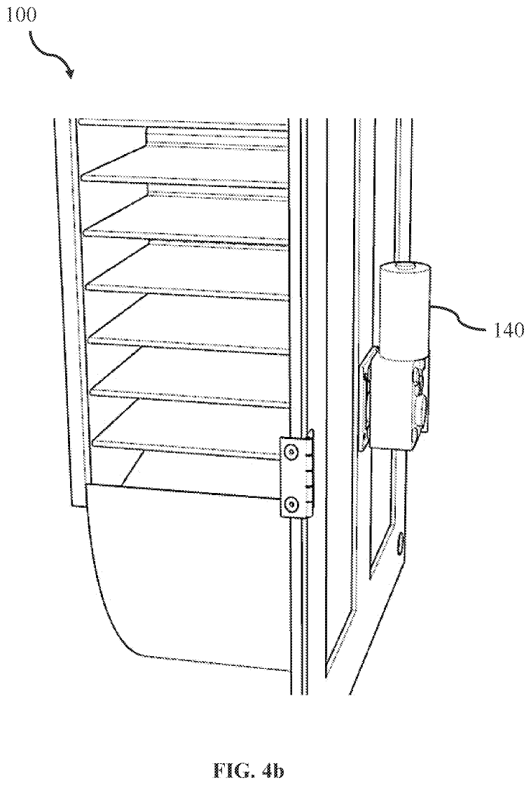

The cartridge (100) also includes a plurality of rotatable rollers (106a-106b) spaced apart from each other and positioned inside the outer looped element (104), and a movable inner looped element (108) mounted on the plurality of rotatable rollers (106a-106b) and positioned inside the outer looped element (104). The spacing between the rollers may depend on what is being conveyed and the amount of chambers that the cartridge requires. However, in other embodiments, a single roller may which is still in the spirt and scope of the present invention. The cartridge (100) may comprise a motor (140) that when powered rotates at least one of the plurality of rotatable rollers (106a), and (106b) so that the movable inner looped element (108) moves. By way of example, the motor may rotate the roller (in the either direction illustrated by curved line B) to move the panels and chambers (in the direction illustrated by line A). Motor (140) is shown by FIGS. 4a-4b. The rotatable rollers (106a-106b) may be hermetically sealed to prevent the accumulation of any food particles inside the rollers. Thus, the hermetically sealed rollers (106a-106b) may provide protection against contamination of the food items stored in the cartridge (100).

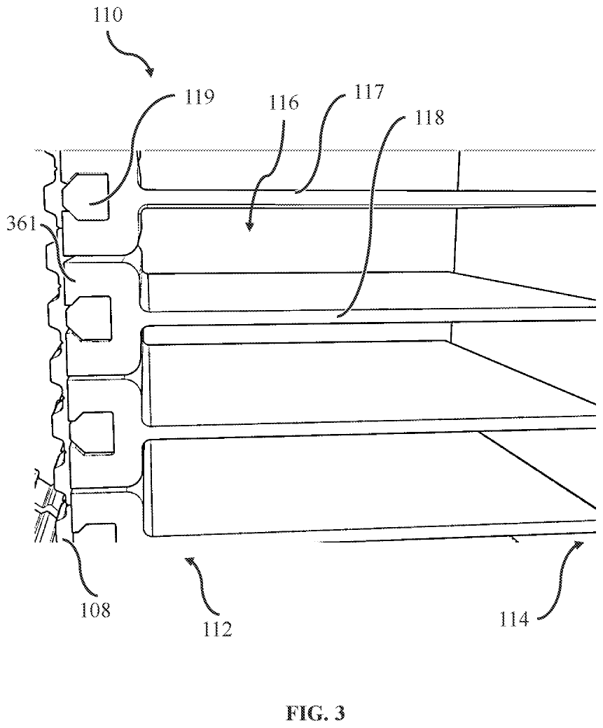

With reference to the Figures now including FIG. 3, a plurality of panels (110) are shown. The plurality of panels are radially attached to the movable inner looped element (108). As illustrated, a first end (112) of each of the plurality of panels (110) is radially attached to the movable inner looped element (108) such that each of the plurality of panels (110) extends toward the outer looped element (104). A second end (114) of each of the plurality of panels (110) may terminate near, or at the outer looped element (104), and more specifically the inward facing wall of the outer looped element. Thus, a second end (114) of the plurality of panels (110) is at least proximate to an inward facing looped wall of the outer looped element (104). It is understood that in certain embodiments the second ends of the panels contact or engage the inward facing looped wall. As mentioned before the inward facing looped wall may be partially defined by the inward facing wall portion (162) of the movable door. Stated differently, the inward facing wall sections (163, 166, 162) may define the inward facing looped wall. The second end (114) of each of the panels (110) may abut the inner side of the outer looped element (104), such that each of the plurality of movable chambers (116) is fully enclosed. In other words, the chamber, which is defined by a set of panels (117, 118), the inward facing looped wall of the outer looped element (104), and the movable inner looped element (108). In certain embodiments, a sealing element (160) may be attached or connected to the second end (114) to each of the panels and the edges that abut the walls of the cartridge so to further assist with facilitating a hermetically sealed chamber. The sealing elements may be an edge trim type seal. The sealing may be an elongated u-shaped body configured to be attached to the edge second on the panel such that mouth of the seal receives the second of the seal and such that the body of the seal contact the inward facing looped wall of the outer looped element. The sealing element may comprise rubber, silicone, or other types of materials configured to form a seal. In other embodiments, the side edges of the panels and second ends of the panels may comprise sealing type material that provide the seal or hermetical seal.

Further, the panels (110) may be attached to the movable inner looped element (108) as follows. The movable inner looped element may include a plurality of holes that are vertically and linearly aligned. A transverse row of holes may be used to mount the panels by way of an insert (not illustrated) that secures an attachment (119) to the movable inner looped element (108). Panels (110) may be attached to the movable inner looped element (108) by simply sliding a receiving portion (361) the panel over the attachment (119). In this way, the panels (110) may be readily removed for cleaning from the inner looped element. Lastly, the movable inner looped element (108) may include a receiving portion configured to receive a tracking tooth (not illustrated) that prevent the belt from sliding off of the rollers. Additionally, a sealing portion may be provided on the panels so that when the panels are installed or mounted on the attachment of the inner loop element, the sealing portion of the receiving portions of adjacent panels contact each other providing a further seal. It is also understood that the elements and components of the inner looped element that interfaces with the panels (and the panels themselves) may comprise seals or sealing elements so that a seal is created between engaging surfaces of the inner looped element and each of the panels.

Defined by the plurality of panels (110) is a plurality of movable chambers (116). The movable chambers (116) extend between the outer looped element (104) and the movable inner looped element (108) and are defined by a space between a first panel (117) and an adjacent panel (118) that is next to the first panel (117). Each chamber may hold one or more food items when the cartridge is charged with food items. For instance, the food item may be a planar food item, or a food item having at least one planar surface. As a non-limiting embodiment, the food item may be used for a burger vending machine. For instance, a patty (e.g., beef, vegetarian, etc.) may be placed in the chamber. One half of a bun may also be placed in the chamber, or a slice of cheese, to name a few. In another aspect, each of the plurality of movable chambers (116) is a hermetically sealed chamber. This prevents the food items from being contaminated.

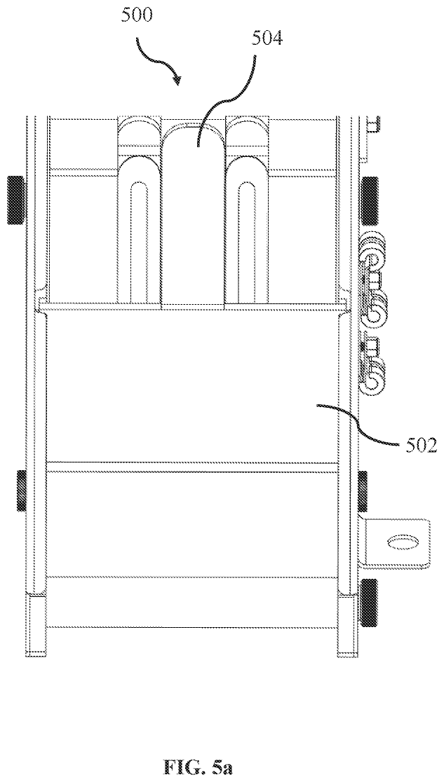

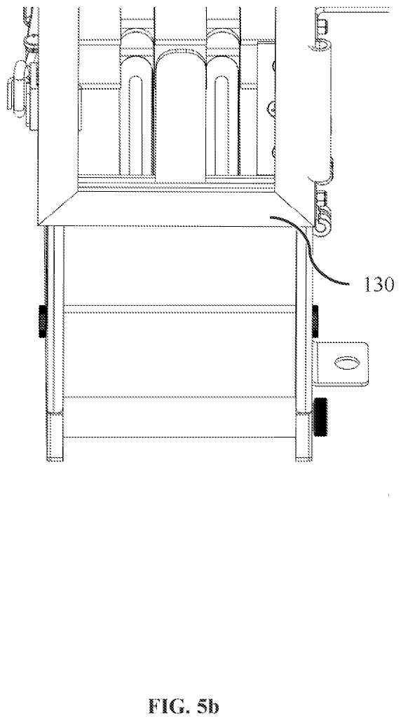

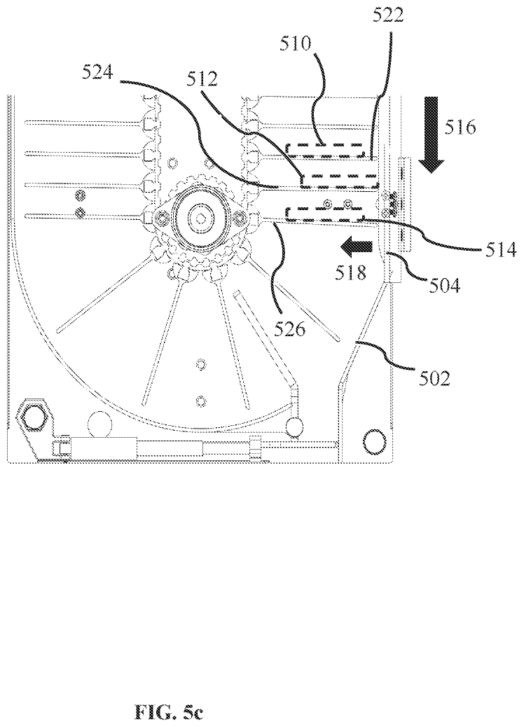

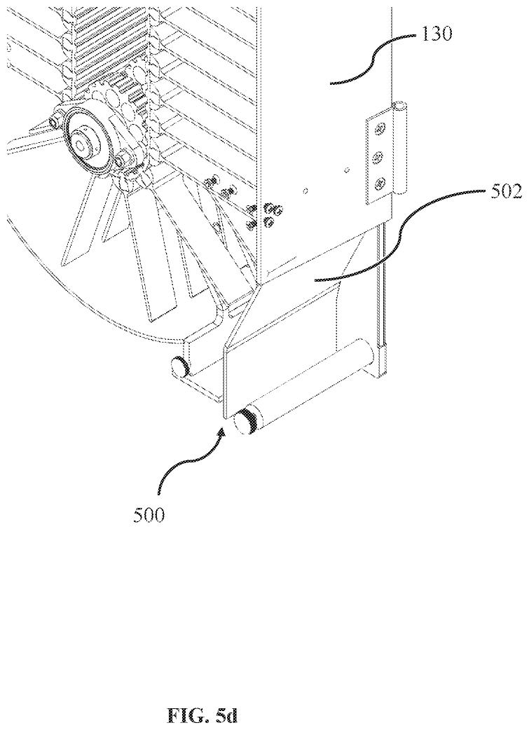

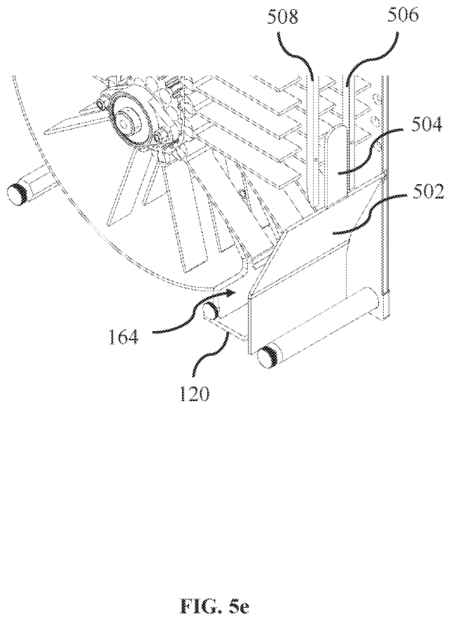

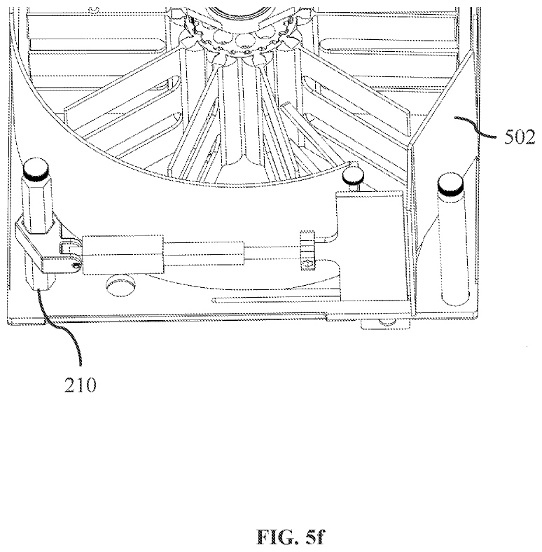

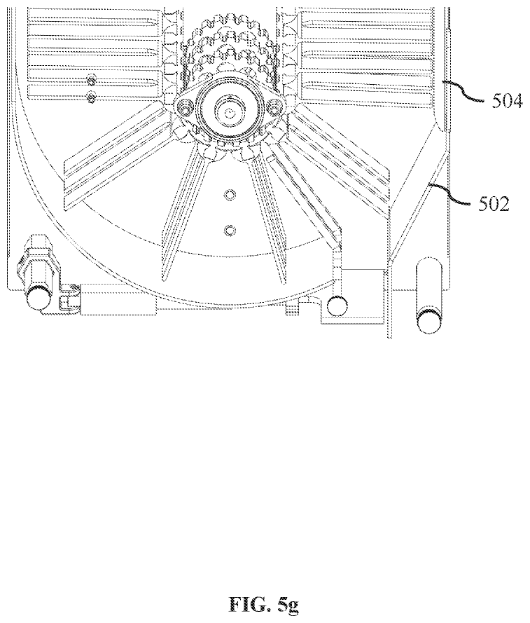

With reference to the Figures now including FIGS. 5a-5g, a repositioning system for repositioning an item or a repositioning system (500) is shown. FIG. 5a shows a bottom portion of the cartridge (100), removably loaded in a food delivery apparatus, having the repositioning system (500). The repositioning system (500) prevents scattering and falling of food items in the cartridge (100) when the movable chambers (116) move along a curve segment in the bottom portion of the cartridge (100). This prevents the cartridge (100) from jamming when food items fall and are trapped between moving or rotating components of the cartridge (100) clogging the movement of the inner looped element (108) and the movable chambers (116).

The repositioning system (500) has a planar surface (502) and an elongated tab (504) that extends from an upper end of the planar surface (502) and protrudes into a portion of the first opening (131). The planar surface (502) is defined by a portion of the outer looped element (104) at a lower end portion of the outer looped element. The planar surface (502) is positioned immediately beneath the outer looped element (104) such that the inner surface of the planar surface (502) is very close to the panels (110) and encloses the movable chambers (116). As shown in FIGS. 5c, 5f and 5g, the planar surface (502) is inclined inwardly towards the panels (110) of the cartridge (100) relative to the elongated tab (504) and a second end of each of the panels (110) is proximate to an inside facing side of the planar surface (502). In an example, the planar surface (502) is inclined inwardly at an angle from about 100 degrees to about 170 degrees with respect to the elongated tab (504). The planar surface (502) with such an inclination supports and retains the food items within the movable chambers (116) when the chambers move along the curve segment of the bottom portion of the cartridge (100).

In an embodiment, the planar surface (502) is made of a transparent material that provides a line of sight from outside the cartridge (100) to inside the cartridge (100) when the first movable door (130) is in a movable door closed position. The planar surface (502) essentially provides a window to a user from outside the cartridge (100) to view the movable chambers (116) and the panels (110) moving during operation of the cartridge (100) for transferring food items. In an example, a camera, sensor, other device may be configured in the vicinity of the cartridge (100) having a field of view focused on the planar surface (502) to monitor operation of the cartridge (100) through the window and detect falling or scattering of pieces from the food items that may clog the cartridge (100). The images or video captured from the camera may be processed to detect jamming of the cartridge (100). In another example, the camera, and the sensor may be configured to detect and monitor if the cartridge (100) is operating properly and if food items are successfully dispensed by the cartridge (100). In case of any anomaly in the operation, such as a jammed situation, or failure to dispense food items, the camera or the sensor alerts an operator or raises an alarm, such that the operator may intervene and resolve the issue. In other embodiments, the planar surface may be made of other types of material that are not transparent. Additionally, in other embodiments the planar surface may not be planar and may have angle edges but that do allow a view from outside the cartridge to inside the cartridge. The planar surface may also be curved. In the present embodiments, the planar surface may be rectangular. However, in other embodiments, other shapes may be used and are within the spirit and scope of the present invention.

The elongated tab (504) protrudes in an upward direction and is substantially vertically arranged such that the elongated tab (504) aligns with the movable door (130) of the cartridge (100) when the movable door (130) is closed. FIGS. 5b and 5d illustrate the movable door closed position when the movable door (130) is closed and an outward most surface of the elongated tab (504) is disposed either very close to the movable door (130) or abuts an inside facing surface of the movable door (130) in the closed position. As shown in FIG. 5e, the elongated tab (504) has a substantially rectangular shape and has a curved top end. In an example, the width of the elongated tab (504) is such that the elongated tab (504) is positioned in between two elongated rails (506) and (508), in the movable door closed position. In the present embodiment, the elongated tab is a planar shaped body having a curved upper end. However, in other embodiments other shapes may be used and are within the spirit and scope of the present invention. For example, the elongated tab may be non-planar and may not have a curve shape upward end.

In an example embodiment, the first movable door (130) has the two elongated rails (506) and (508) disposed on the inward facing wall portion (162) of the first movable door (130). The elongated rails (506) and (508) are parallel to each other and extend substantially along a full length of the first movable door (130). In other embodiments, only one rail is used. In other embodiments, the rail may not span the entire movable door but only a shorter portion of the movable door. Each of the panels (110) have one or more cutouts that extend from the second end of the panels (110) towards the first end of the panels (110) along a portion of the length of the panel. In the movable door closed position, the cutouts receive a portion of the elongated rails (506) and (508) and the elongated tab (504) is positioned in between the two elongated rails (506) and (508), as shown in FIG. 5e. In one embodiment, each of the cutouts comprise an opening that is sized such that it can receive an elongated rail therein. The elongated rails (506) and (508) in such a position prevents the food items from falling off the movable chambers (116) when the chambers move along the curve at the bottom of the cartridge (100). The elongated rails (506) and (508) push and retain the food items in the movable chambers (116) when the chambers move along the curve of the cartridge (100).

In an example, the elongated rails (506) and (508) may be coupled to the inward facing wall portion (162) of the first movable door (130) via one of bolts and nuts, welding an outer surface of the elongated rails to the inward facing wall portion of the movable door (130), or using a snap-fit mechanism. In an embodiment, the inward most surface of the elongated tab (504) is flush against the outfacing surface of the elongated rails (506) and (508). In another embodiment, the inward most surface of the elongated tab (504) is disposed outward relative to an outfacing surface of the elongated rails, such that there is a gap in between the inward most surface of the elongated tab (504) and the outfacing surface of the elongated rails (506) and (508). In one embodiment, the elongated rails are elongated shaped having a square cross sectional shaped body. However, in other embodiments, other shapes may be used and are within the spirit and scope of the present invention. For example, in one embodiment, each elongated rail may have a curved shape surface that extends inward when the door is closed. Additionally, in other embodiments, the cross-sectional shape may be triangular, circular, oval, etcetera.

In an embodiment, a second movable door (120) covers an opening (164) that is disposed on the outer looped element (104) that provides access to outside the cartridge (100). The second movable door (120) is disposed on the outer looped element (104) proximate to a bottom end of the outer looped element (104). In this aspect, the movable door (120) enables the cartridge to dispense food items stored inside the cartridge to outside of the cartridge. The shape and size of the second door and opening may be adjusted depending on the size of the food item to be delivered. In another embodiment, as shown in FIG. 5g, the panels (110) may have a different structure and shape having the cutouts extending from the second end to the first end of a panel along the entire length of the panel (110). The different shapes and size of panels (110) may be used to deliver different types of food items having different shapes and sizes.

The cartridge method of operation includes first charging the cartridge with a plurality of food items. In other words, a food item is added to each of the movable chambers. Each food item is stored in a respective chamber. The food items are generally charged into the cartridge in a food safe environment that complies with local laws and regulations that minimize contamination that can cause foodborne illnesses. After charging the cartridge with the food items, the cartridge is sealed. As noted above, one benefit of the cartridge is that the food items are hermetically sealed inside the cartridge. After sealing the cartridge, the cartridge containing the food items therein is then transported to the location that it will be consumed at. For instance, in one embodiment the cartridge is used in a vending machine that serves burgers. In the vending machine, one-by-one, food items are dispensed through the second movable door (120) and opening (164) described above. After a food item is dispensed through the opening (164), the motor (140) engages to move the rotatable rollers, which thereby move the discharged chamber away from the door and a charged chamber to the door. One-by-one, each food item can be dispensed as required by the user. Thus, the cartridge enables on-demand dispensing of food items. The opening (164) may have a shape that may be adjusted for the size of certain food items. In another embodiment, the cartridge may include a chute apparatus that is in connection with the door (120), which is opened and closed by a first actuator (210).

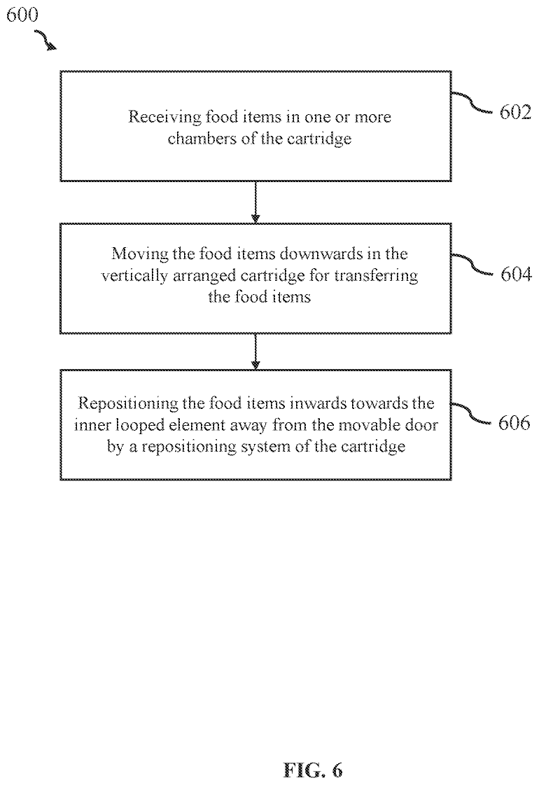

FIG. 6 is a flowchart (600) of an example method for storing and conveying food items in a cartridge of a food delivery apparatus, in accordance with an embodiment of the invention. The cartridge, for example, is the cartridge (100) having the outer looped element (104) and the inner looped element (108). In operation, in step 602, food items are received in one or more chambers of the cartridge (100). For example, when the cartridge is deployed in a restaurant, the cartridge may be loaded with food items at one end by a staff member such that the food items are conveyed and dispensed at another end. The food items may be for example, patties or burgers placed on the panels of the cartridge (100). As shown in FIG. 5c, the food items (510), (512), and (514) are placed on the panels (522), (524), and (526) respectively inside the cartridge (100). In step 604, the food items are moved downwards in the vertically arranged cartridge for transferring the food items. The motor of the cartridge moves the food items (510), (512), and (514) in the downward direction as shown by the arrow (516) in FIG. 5c. During the movement of the cartridge, the food items may shift outwards towards the outer looped element (108). FIG. 5c shows an example, when the food item (512) shifts towards the movable door (130) when the motor moves the cartridge in the downward direction. As the food items move towards the movable door (130), on many instances, the food items may unwantedly fall out of the chambers and may get stuck in gaps between the panels and the outer looped element (108) or the movable door (130). In another example, when the food items are disposed in an unwanted position too close to the movable door (130), then the food items may fall out of the chambers during movement. The repositioning system prevents this unwanted falling of the food items during the downward movement and reduces instances of the falling food items getting stuck in between the gaps. In step 606, the food items are repositioned inwards towards the inner looped element (104) away from the movable door by the repositioning system of the cartridge. For example, the food items (510), (512), and (514) may be pushed inwards by the elongated tab (504) of the repositioning system (500) to move the food items (510), (512), and (514) away from the movable door (130), as indicated by the arrow (518) in FIG. 5c.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A cartridge for storing and conveying food items in a food delivery apparatus, the cartridge comprising:
a housing having a plurality of walls defining a main cavity;
an outer looped element affixed at least partially in the main cavity, wherein the outer looped element has a length;
at least one roller positioned inside the outer looped element;
a movable inner looped element mounted on the at least one roller and positioned inside the outer looped element;
a plurality of panels, wherein a first end of each of the plurality of panels is radially attached to the movable inner looped element such that each of the plurality of panels extends toward the outer looped element;
a plurality of movable chambers between the outer looped element and the movable inner looped element, wherein each of the plurality of movable chambers is defined by a space between a first panel of the plurality of panels and an adjacent panel of the plurality of panels that is next to the first panel;
a first opening that spans substantially all of a first side of the outer looped element;
a movable door covering substantially all of the first opening and partially defining the outer looped element when the movable door is in a movable door closed position;
a portion of the outer looped element defining a planar surface at a lower end portion of the outer looped element; and
an elongated tab extending from an end of the planar surface and protruding into a portion of the first opening.

2. The cartridge of claim 1, wherein the planar surface is transparent providing a line of sight from outside the cartridge to inside the cartridge when the movable door is in the movable door closed position.

3. The cartridge of claim 1, wherein a second end of the plurality of panels is at least proximate to an inside facing side of the planar surface.

4. The cartridge of claim 1, wherein the elongated tab is substantially vertically arranged.

5. The cartridge of claim 1, wherein at least one elongated rail is disposed along an inside facing surface of the movable door.

6. The cartridge of claim 5, wherein each of the plurality of panels has at least one cutout that receives a portion of the at least one elongated rail when the movable door is in the movable door closed position.

7. The cartridge of claim 1, wherein when the movable door is in the movable door closed position, an outward most surface of the elongated tab is disposed at least one of (i) very close to and (ii) abutting an inside facing surface of the movable door.

8. The cartridge of claim 5, wherein when the movable door is in the movable door closed position, an inward most surface of the elongated tab is disposed at least one of (i) flush and (ii) outward relative to an outfacing surface of the at least one elongated rail.

9. A repositioning system for a cartridge for storing and conveying food items in a food delivery apparatus, the cartridge having a housing defining a main cavity, an outer looped element affixed at least partially in the main cavity, and a first opening that spans substantially all of a first side of the outer looped element, the repositioning system comprising:
a portion of the outer looped element defining a planar surface at a lower end portion of the outer looped element; and
an elongated tab extending from an end of the planar surface and protruding into a portion of the first opening.

10. The repositioning system of claim 9, wherein the elongated tab is substantially vertically arranged.

11. The repositioning system of claim 9, wherein the planar surface is transparent providing a line of sight from outside the cartridge to inside the cartridge.

12. The repositioning system of claim 9, wherein the planar surface is inclined inwardly towards panels of the cartridge relative to the elongated tab.

13. The repositioning system of claim 9, wherein the elongated tab is substantially rectangular shaped.

14. A cartridge to be removably loaded in a food delivery apparatus for storing and conveying food items, the cartridge comprises:
a housing having a plurality of walls defining a main cavity;
an outer looped element affixed at least partially in the main cavity;
at least one roller positioned inside the outer looped element;
a movable inner looped element mounted on the at least one roller and positioned inside the outer looped element;
a plurality of panels, wherein a first end of each of the plurality of panels is radially attached to the movable inner looped element such that each of the plurality of panels extends toward the outer looped element, wherein a first panel of the plurality of panels and an adjacent panel of the plurality of panels that is next to the first panel define a chamber;
a first opening that spans substantially all of a first side of the outer looped element;
a movable door covering substantially all of the first opening and partially defining the outer looped element when the movable door is in a movable door closed position, wherein each of the plurality of panels has at least one cutout that receives a portion of at least one elongated rail disposed along an inside facing surface of the movable door when the movable door is in the movable door closed position;
a portion of the outer looped element defining a planar surface at a lower end portion of the outer looped element; and
an elongated tab extending from an end of the planar surface and protruding into a portion of the first opening.

15. The cartridge of claim 14, wherein the cartridge comprises a second opening disposed on the outer looped element proximate to a bottom end of the outer looped element providing access to outside the cartridge.

16. The cartridge of claim 14, wherein when the movable door is in the movable door closed position, an outward most surface of the elongated tab is disposed at least one of (i) very close to and (ii) abutting an inside facing surface of the movable door.

17. The cartridge of claim 14, wherein when the movable door is in the movable door closed position, an inward most surface of the elongated tab is disposed at least one of (i) flush and (ii) outward relative to an outfacing surface of the at least one elongated rail.

18. The cartridge of claim 14, wherein the cartridge comprises a motor that when powered rotates at least one rotatable roller so that the movable inner looped element moves.

19. The cartridge of claim 14, wherein the outer looped element has a height that spans from a first inside surface of a first side wall of one of the plurality of walls to a second inside surface of a second side wall of one of the plurality of walls.

20. The cartridge of claim 14, wherein a second end of each of the plurality of panels abuts an inner side of the outer looped element such that each movable chamber is fully enclosed.
